(19) United States
(12) Patent Application Publication
(10) Pub. No.: US 2007/0026806 A1
(43) Pub. Date: Feb. 1, 2007

(54) Administration terminal, communication terminal, wireless communication system, and wireless communication method

(75) Inventors: Shinji Kuroda, Fukuoka (JP); Hironori Tanaka, Fukuoka (JP)

Correspondence Address: STEVENS, DAVIS, MILLER & MOSHER, LLP, 1615 L. STREET N.W., SUITE 850, WASHINGTON, DC, 20036, US

(73) Assignee: MATSUSHITA ELECTRIC INDUSTRIAL CO., LTD., Osaka (JP)

(21) Appl. No.: 11/493,854

(22) Filed: Jul. 27, 2006

(30) Foreign Application Priority Data
Jul. 29, 2005 (JP) P. 2005-219980

(51) Int. Cl. H04B 15/00; H04B 1/44

(52) U.S. Cl. 455/63.3; 455/78

(57) ABSTRACT

An administration terminal, a communication terminal, a wireless communication system, and a wireless communication method, in which frames can be transmitted/received in excellent communication quality by avoiding interference when an administration terminal and a communication terminal suffer from interference with electronic devices that use the same frequency. Between the administration terminal and the communication terminal, while the reference frequency for transmitting/receiving the reference frame is not changed, the switching is performed into a non-reference frequency different from the reference frequency at least one time within the reference frame interval at the same timing, so that frames can be transmitted/received using one or more frequency including the reference frequency and one or more non-reference frequency.

### BACKGROUND

The present invention relates to an administration terminal for administrating communication terminals used in a wireless communication such as a wireless LAN, a communication terminal controlled by the administration terminal, a wireless communication system including an administration terminal and a plurality of communication terminals, and a wireless communication method.

In a conventional local area network (hereinafter, referred to as a LAN), various kinds of devices are connected to a network through cables such as a LAN cable or a coaxial cable. However, since wire connections have complicated constructions or cables, a wireless LAN is widely used recently.

According to IEEE 802.11, a most widely used wireless LAN standard, frames are transmitted and received between an administration terminal and communication terminals controlled by an administration terminal using the same frequency range. When electromagnetic wave interference is generated between these terminals and other electronic devices that use the same frequency range, frames are transmitted/received in a bad communication quality condition, and a frame loss rate increases, so that the communication link may be terminated.

As a technology for preventing interference, a method of retrieving frequencies and initiating communication using an unoccupied frequency is disclosed in the patent document 1. Also, a method of converting the frequency used between the administration terminal and the communication terminals connected thereto into another frequency when interference is generated and resuming the communication is disclosed in the patent document 2.

According to IEEE 802.11.b, the interference is not generated when the channels CH are separated into five channels CH1 to CH5. For example, if there is only four channel difference as between the channels CH1 and CH5, a high-frequency range of the channel CH1 and the low-frequency range of the channel CH5 may be overlapped, so that they can be interfered with each other.
[Patent Document 1] Japanese Unexamined Patent Publication No. 2003-249973
[Patent Document 2] Japanese Unexamined Patent Publication No. 2004-235710

However, the aforementioned conventional technologies cannot be applied to the conditions shown in FIG. 16. Referring to FIG. 16, an administration terminal 1a and three communication terminals 2a, 2b, and 2c are connected to each other via the channel CH2, but each communication terminal is also within the range of other administration terminals 1b, 1c, and 1d.

For example, when the administration terminals 1a, 1b, 1c, and 1d are used by different subscribers in an apartment environment, each network corresponding to each administration terminal is completely separated. Therefore, the communication terminals 2a, 2b, and 2c cannot be connected to the administration terminals 1b, 1c, and 1d other than the administration terminal 1a.

In this case, the administration terminals 1b, 1c, and 1d use the channels CH1, CH6, and CH11, respectively, and the administration terminals 1b and 1b commonly use the same channel. Therefore, the communication terminal 2a resides in the area where the radio wave of the administration terminal 1b can be reached, so that the administration terminal 1b functions as an interference source of the administration terminal 2a. In this situation, when all of the administration terminal 1a and the administration terminals 2a, 2b, and 2c are simultaneously converted into the channel CH6 in order to improve communication quality between the administration terminal 1a and the communication terminal 2a, the administration terminal 1c interferes with the communication terminal 2b. Otherwise, when all of the administration terminal 1a and the administration terminals 2a, 2b, and 2c are simultaneously converted into the channel CH11, the administration terminal 1d also interferes with the communication terminal 2c.

### SUMMARY

It is an advantage of the present invention to provide an administration terminal, a communication terminal, a wireless communication system, and a wireless communication method, in which frames can be transmitted/received with excelled communication quality by preventing the interference that can be generated even when an administration terminal or a communication terminal interferes with other administration terminals or communication terminals.

The present invention provides a communication system including-an administration terminal and a plurality of communication terminals, wherein the communication terminals are administrated by the administration terminal. Between the administration terminal and the communication terminals, while the reference frequency for transmitting/receiving the reference data is not changed, the switching is performed into a non-reference frequency different from the reference frequency at least one time within the reference data interval at the same timing, so that data can be transmitted/received using one or more frequencies including the reference frequency and one or more non-reference frequencies.

As a result, data can be transmitted/received using one ore more frequencies having excellent communication quality among a reference frequency and one or more non-reference frequencies to avoid the interfering frequency. Therefore, it is possible to safely transmit/receive data between the administration terminal and the communication terminal.

According to the present invention, data can be transmitted/received even in the non-reference frequency to avoid the interfering reference frequency by switching into the non-reference frequency within a reference data interval. As a result, it is possible to safely transmit/receive data between the administration terminal and the communication terminal. In other words, it is possible to improve quality of service, particularly, in an IP telephone and the like.

According to the first aspect of the present invention, there is provided a communication system including an administration terminal and a plurality of communication terminals, wherein the communication terminals are administrated by the administration terminal. Between the administration terminal and the communication terminals, while the reference frequency for transmitting/receiving the reference data is not changed, the switching is performed into a non-reference frequency different from the reference frequency at least one time within the reference data interval at the same timing, so that data can be transmitted/received using one or more frequency including the reference frequency and one or more non-reference frequencies.

Accordingly, data can be transmitted/received even in the non-reference frequency to avoid the interfering reference frequency by switching into the non-reference frequency within a reference data interval. As a result, it is possible to safely transmit/receive data between the administration terminal and the communication terminal.

According to the second aspect of the present invention, in addition to the first aspect of the invention, the administration terminal adds frequency switching notification information including at least one of a frequency of the non-reference frequency, a frequency switching timing, and a duration after the frequency is switched into a reference data to the reference data to transmit it, or generates frequency switching notification data including the frequency switching notification information to transmit it. Between the administration terminal and the communication terminals, while the reference frequency for transmitting/receiving the reference data is not changed, the switching is performed into the non-reference frequency within the reference data interval at the same timing based on the frequency switching notification information, so that data can be transmitted/received using one or more frequencies including the reference frequency and one or more non-reference frequencies.

As a result, the administration terminal can optimally determine the non-reference frequency or the frequency duration as occasion occurs depending on interference conditions by dynamically changing a frequency of the non-reference frequency, a timing for switching into the non-reference frequency, durations of the reference frequency and the non-reference frequency to transmit it to the communication terminal. Therefore, it is possible to transmit/receive data in more improved communication conditions.

According to the second aspect of the present invention, in addition to the first aspect of the invention, the communication terminal detects one or both of interference on the administration terminal and interference on the communication terminal that is administrated by the administration terminal and adds the frequency switching request information for requesting frequency switching to the administration terminal to a data having another purpose to transmit it, or generates a frequency switching request data including frequency switching request information to transmit it, while the administration terminal generates frequency switching notification information based on the frequency switching request information of the received data, so that the administration terminal and the communication terminal switch into the non-reference frequency at the same timing based on the frequency switching notification information within a reference data interval.

Accordingly, when the communication terminal detects interference and issues a request, it is possible to transmit/receive data with an optimal frequency or duration.

According to the fourth aspect of the present invention, in addition to the first aspect of the invention, the administration terminal detects one or both of interference on the administration terminal and interference on the communication terminal that is administrated by the administration terminal and generates the frequency switching notification information based on that to transmit it.

Accordingly, the administration terminal detects interference, and generates the frequency switching notification information based on that, so that it is possible to transmit/receive data with an optimal frequency or duration in the administration terminal.

According to the fifth aspect of the present invention, in addition to the first aspect of the invention, the administration terminal generates the frequency switching notification information based on the one or both of interference on the administration terminal and interference on the communication terminal that is administrated by the administration terminal and the frequency switching request information of the received frequency switching request data to transmit it.

Accordingly, it is possible to optimally select the frequency and the duration for both of the administration terminal and the communication terminal. Therefore, it is possible to more safely transmit/receive data.

### BRIEF DESCRIPTION OF THE DRAWINGS

FIG. 1 is an exterior perspective view illustrating a front side of an administration terminal.

FIG. 2 is an exterior perspective view illustrating a rear side of an administration terminal.

FIG. 3 is a block diagram illustrating an example of a hardware construction of an administration terminal.

FIG. 4 is an exterior perspective view illustrating a communication terminal.

FIG. 5 is a block diagram illustrating an example of a hardware construction of a communication terminal.

FIG. 6 is a functional block diagram illustrating an administration terminal.

FIG. 7 is a functional block diagram of a communication terminal.

FIG. 8 is a timing chart illustrating operations of a communication system according to the first embodiment of the present invention.

FIG. 9 is a timing chart illustrating operations of a communication system according to the second embodiment of the present invention.

FIG. 10 is a timing chart illustrating operations of communication system according to the third embodiment of the present invention.

FIG. 11 is a constructional view illustrating a physical layer frame according to a standard IEEE 802.11.

FIG. 12 is a constructional view illustrating details of a frame body of an Action frame.

FIG. 13 is a constructional view illustrating details of frequency switching notification information according to the second embodiment of the present invention.

FIG. 14 is a constructional view illustrating details of a frame body of a beacon frame.

FIG. 15 is a constructional view illustrating details of frequency switching request information according to the third embodiment of the present invention.

FIG. 16 is a constructional view illustrating an example of a communication system.

### DESCRIPTION OF EMBODIMENTS

Hereinafter, each embodiment of the present invention will be described with reference to the accompanying drawings.

### Embodiment 1

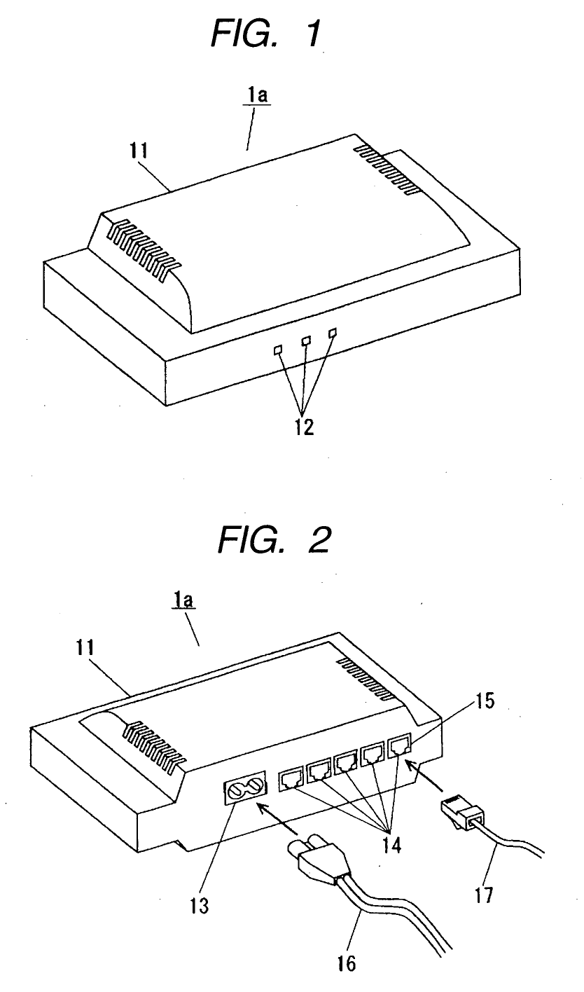

The first embodiment of the present invention will be described with reference to FIGS. 1 to 8, and FIG. 16.

FIG. 1 is a perspective view illustrating a front side of an administration terminal, and FIG. 2 is a perspective view illustrating a rear side of an administration terminal.

In this embodiment, the administration terminal I a is a router as shown in FIGS. 1 and 2. The administration terminal 1a has a casing 2, and a display unit 12 such as a light emitting diode (LED) is provided on the front face of the casing 11. As shown in FIG. 2, a direct current (DC) power supply connector 13, a LAN modular jack 14 such as an RJ45, and a WAN modular jack 15 are provided on the rear face of the casing 11. As shown in FIG. 2, a power cable 16 such as a parallel cable is connected to the DC power connector 13. ALAN cable 17 is connected to the modular jacks 14 and 15. Although a router is shown in FIGS. 1 and 2 as an example of the administration terminal, any device having an access point (for example, electronic appliances such as a television set) may be used as the administration terminal, and the present invention is not particularly limited thereby.

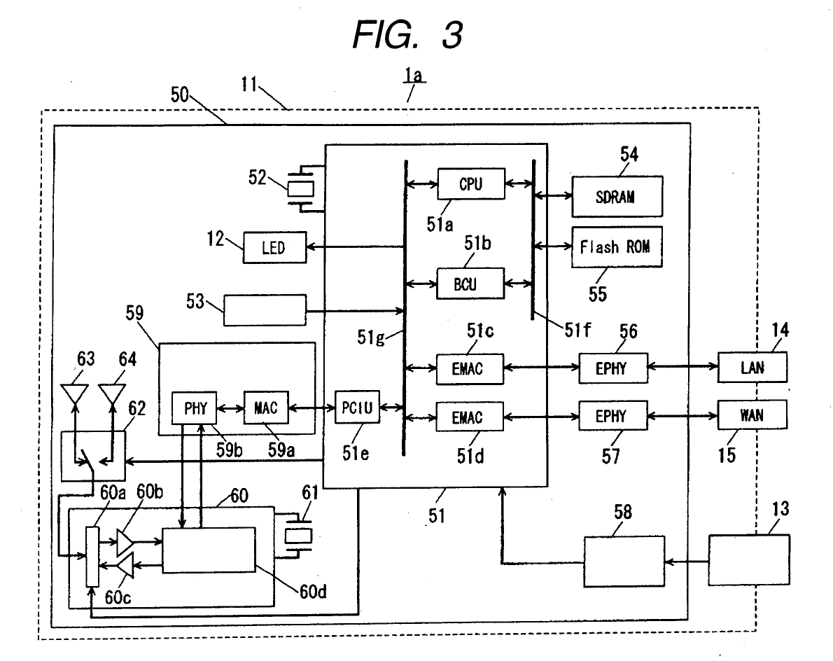

FIG. 3 is a block diagram illustrating a hardware construction of an administration terminal.

As shown in FIG. 3, the administration terminal 1a has a circuit module 50 in the casing 11 shown as a dashed line. A main integrated circuit (IC) 51, a wireless LAN controller 59, and an RF module 60 are mounted on the circuit module 50.

The main IC 51 includes a central processing unit (CPU) 51a, a bus such as a main bus 51f and a local bus 51g, a bust control unit (BCU) 51b for controlling the data flow on the bus, an MAC block for controlling a media access control (MAC) layer of an Ethernet (Registered Trademark), and a PCIU 51e for controlling a peripheral component interconnect (PCI) unit bus.

The CPU 51a and the BCU 51b in the main IC 51 are connected to the synchronous dynamic random access memory (SDRAM) 54 and Flash read only memory (ROM) 55 via the main bus 51f. The CPU 51a and the BCU 51b are connected to an oscillator 52 for supplying clocks to the main IC 51 and the reset IC 53 for outputting a setup signal to the display unit 12 such as an LED and the main IC 51 via the local bus 51g.

The MAC blocks 51c and 51d in the main IC 51 are connected to the physical layer (PHY) ICs 56 and 57, respectively, that control the physical layer in the Ethernet (Registered Trademark). The PHY ICs 56 and 57 are connected to the WAN modular jack 15 and the LAN modular jack 14, respectively. The main IC 51 is connected to the DC power connector 13 via a DC-DC converter 58. The DC-DC converter 58 converts a DC voltage supplied from the DC power connector 13 into a DC voltage necessitated in the main IC 51.

The wireless LAN controller 59 has a MAC block 59a for controlling the MAC layer and a PHY block 59b for controlling a physical layer. The PCIU 51e in the main IC 51 is connected to the PHY block 59b via the MAC block 59a.

The RF module 60 includes a transmit/receive switch 60a for switching between transmit and receive states set by the main IC 51, a low noise amplifier (LNA) 60b for amplifying a receive signal, a power amplifier (PA) 60c for amplifying a transmission signal, and a radio frequency (RF) modulator/demodulator 60d for modulating and demodulating the RF signal.

The RF module 60 is connected to the oscillator 51 for supplying clocks to the RF module 60, and the RF modulator/demodulator 60d in the RF module 60 is connected to the PHY block 59b in the wireless LAN controller 59. The transmit/receive switch 60a in the RF module 60 is connected to antennas 63 and 64 via an antenna switch 62 that switches the antenna used by the main IC 51.

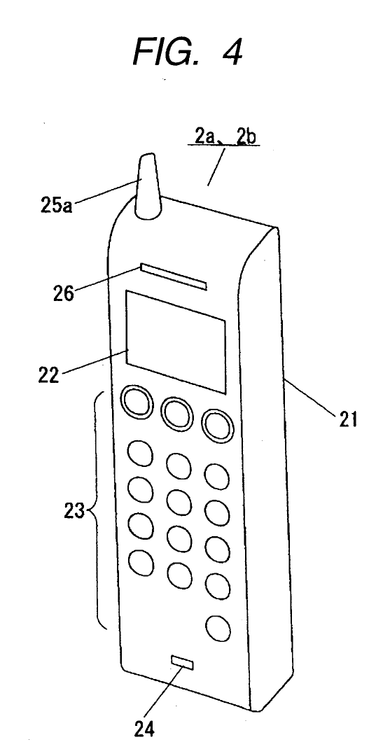

FIG. 4 is a perspective view illustrating an example of a communication terminal.

In this embodiment, the communication terminals 2a and 2b are mobile phones as shown in FIG. 4. The communication terminal 2a or 2b has a casing 21. The casing 21 includes a liquid crystal display (LCD) 22 for displaying phone numbers, a key matrix 23 including buttons for entering the phone number, a microphone 24, an external antenna 25a for transmitting and receiving electric waves, and a speaker 26 for outputting voices from a phone talker. In addition, although a mobile phone is shown in FIG. 4 as an example of a communication terminal, any device (for example, an electronic device such as a personal computer) that can be connected to an access point may be used as a communication terminal, and there is no need to particularly limit it to the phone.

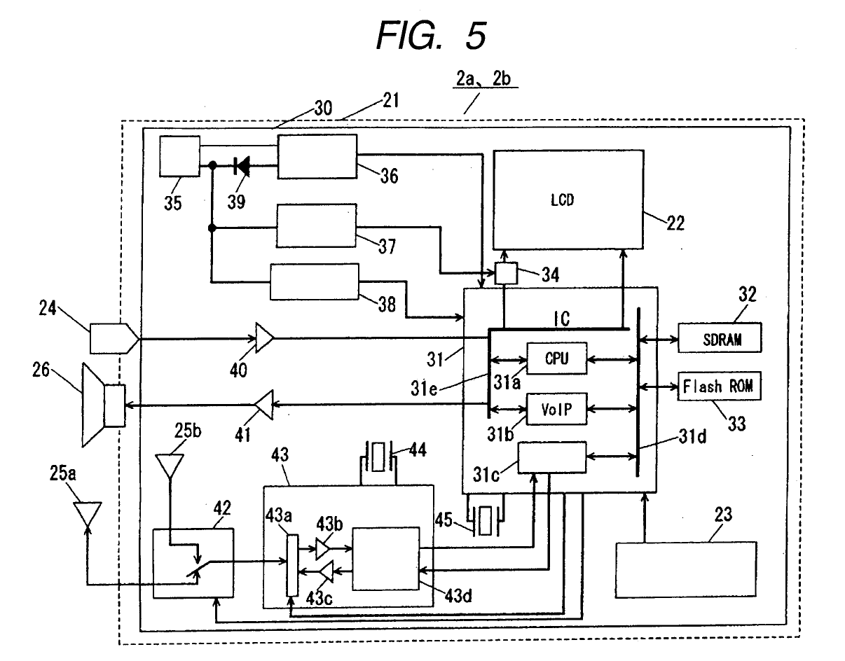

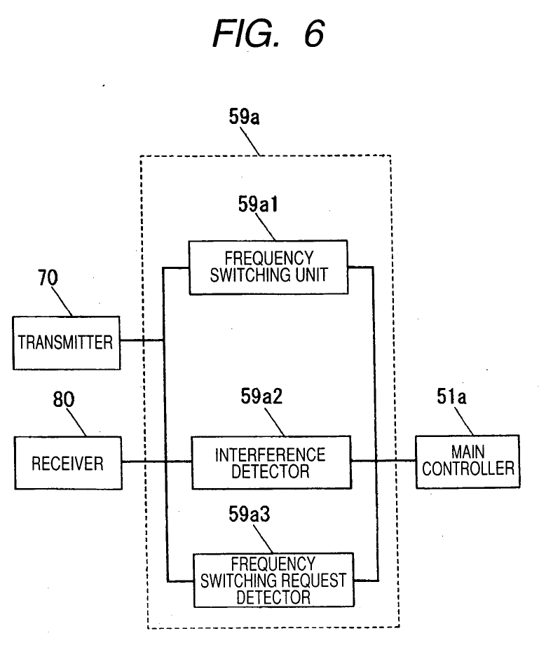

FIG. 5 is a block diagram illustrating an example of a hardware construction of a communication terminal.

Referring to FIG. 5, the communication terminals 2a and 2b have a circuit module in the casing 21 shown as a dashed line. A baseband IC 31 and a RF module 4B are mounted on the circuit module 30 in addition to the LCD 22 and the key matrix 23 that have been described in association with FIG. 4.

The baseband IC 31 includes a CPU 31a, a voice over Internet protocol (VoIP) block 31b for processing voices, a wireless MAC block 31c for controlling the MAC layer of the wireless LAN, and a path such as a main bus 31d and a local bus 31e.

The CPU 31a, the VoIP block 31b, and the wireless MAC block 31c in the baseband IC 31 are connected to the SDRAM 32 and the flash ROM 33 via the main bus 31d. The CPU 31a and the VoIP block 31b are connected to the LCD 22, the LCD power control IC 34 for controlling the power of the LCD, the DC-DC converter 36 for obtaining a required DC voltage, and the reset IC 38 for outputting an initialization signal to the baseband IC 31 via the local bus 31c. The DC-DC converter 36 is connected to the battery 35 via the diode 39, and the LCD voltage buster circuit 37 for busting a voltage level as much as required in the LCD 22 is connected to the battery 35.

The CPU 31a and the VoIP block 31b are connected to the amplifier 40 for amplifying the signal from the microphone 24 and the amplifier 41 for amplifying the signal to the speaker 26 via the local bus 31e. The amplifiers 40 and 41 are connected to the microphone 24 and the speaker 26. The baseband IC 31 is connected to the baseband IC 31, the oscillator 45 for supplying a clock signal to the key matrix 23, the RF module 43, and the antenna switch 42 for switching the antenna from the baseband IC 31.

The RF module 43 includes a transmit/receive switch 43a, a low noise amplifier (LNA) 43b for amplifying a receive signal, a power amplifier (PA) 43c for amplifying a transmit signal, and an RF modulator/demodulator 43d for modulating and demodulating the RF signals. The RF module 43 is connected to the oscillator 44 for supplying clocks to the RF module 43 and the antenna switch 42. The antenna switch 42 is connected to the external antennas 25a and 25b that have been described in association with FIG. 4.

FIG. 6 is a functional block diagram illustrating an administration terminal 1a. Referring to FIG. 6, the administration terminal 1a includes a transmitter 70, a receiver 80, a frequency switching unit 59a1, an interference detector 59a2, a frequency switching request detector 59a3, and a main controller 51a corresponding to the CPU of FIG. 3. The transmitter 70 and the receiver 80 have a RF module 60, an oscillator 61, an antenna switch 62, and antennas 63 and 64. The frequency switching unit 59a1, the interference detector 59a2, and the frequency switching request detector 59a3 are included in part of the MAC 59a of FIG. 3. The transmitter transmits the frame to the air, and the receiver 80 receives the frames from the air, so that the received frames are passed to the frequency switching request detector 59a3. When a frame including the frequency switching request information is detected, the frequency switching request information is notified to the main controller 51a. When the interference detector 59a2 detects one or both of interference on the administration terminal and interference on the communication terminal that is administrated by the administration terminal, the detection result is notified to the main controller 51a. The main controller 51a generates frequency switching notification information based on the detection result and adds it to the reference frame, or generates a frequency switching notification frame to transmit it to the transmitter 70. The frequency switching unit 59a1 switches the frequency under the control of the main controller 51a based on the frequency switching notification information.

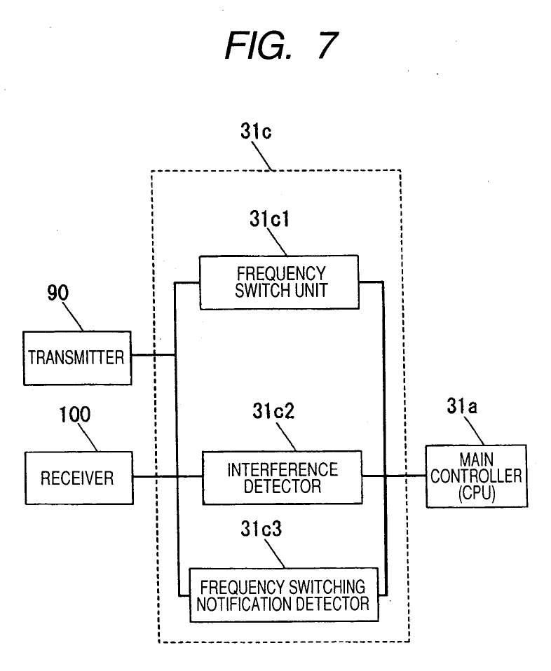

FIG. 7 is a functional block diagram illustrating communication terminals 2a and 2b. Referring to FIG. 7, the communication terminal 2a and 2b includes a transmitter 90, a receiver 100, a frequency switching unit 31c1, an interference detector 31c2, a frequency switching notification detector 31c3, and a main controller 31a. The transmitter 90 and the receiver 100 have a RF module 43, an oscillator 44, an antenna switch 42, and external antennas 25a and 25b. The frequency switching unit 31c1, the interference detector 31c2, and the frequency switching notification detector 31c3 are included in part of the wireless MAC 31c of FIG. 5. The transmitter 90 transmits the frames to the air, and the receiver receives the frames from the air, so that the received frames are passed to the frequency switching notification detector 31c3. When a frame having the frequency switching notification information is detected, the frequency switching notification information is notified to the main controller 31a. When the interference detector 31c2 detects one or both of interference on the administration terminal and interference on the communication terminal that is administrated by the administration terminal, the detection result is notified to the main controller 31a. The main controller 31a generates a frequency switching request frame including the frequency switching request information for requesting to switch the frequency based on the detection result notified from the interference detector 31c2 and transmits it to the administration terminal. Also, the main controller 31a instructs the frequency switching unit 31c1 to switch the frequency based on the frequency switching notification information included in the frame transmitted from the administration terminal. The frequency switching unit 31c1 switches the frequency under the control of the main controller 31a.

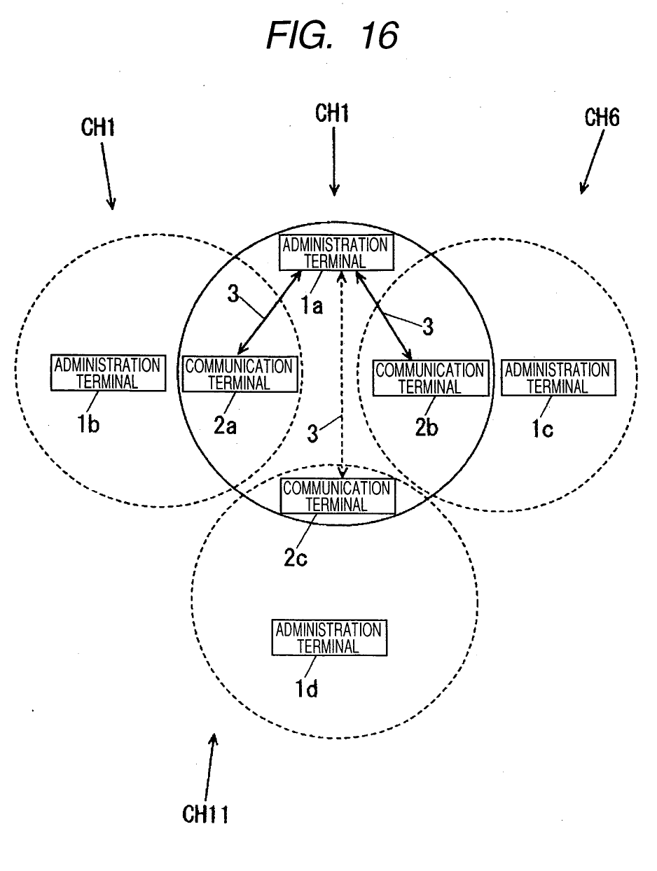

FIG. 16 is a constructional diagram illustrating a conventional communication system that has been described in Background Art, and also illustrates a wireless communication system according to the embodiment of the present invention. The wireless communication system according to the embodiment of the present invention includes an administration terminal 1a and communication terminals 2a, 2b, and 2c. The administration terminal 1a is connected to a wireless LAN through an unvisible wireless communication path 3. In other words, the communication terminals 2a, 2b, and 2c are connected to the administration terminal 1a through a wireless communication path 3, and administrated by the administration terminal 1a through a wireless LAN. In this embodiment, the communication terminals 2a and 2b are in a calling state, and data are periodically transmitted and received. The communication terminal 2c is not in a calling state, and data are not periodically transmitted and received. The descriptions will be particularly made with respect to operations of the administration terminal 1a and the communication terminals 2a and 2b.

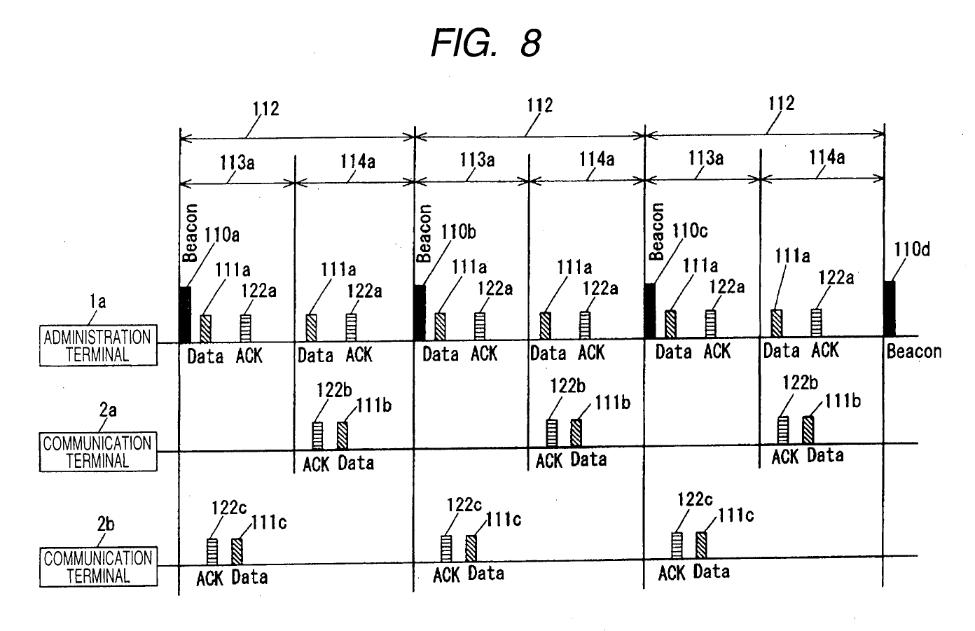

FIG. 8 is a timing chart of a communication system according to the first embodiment of the present invention in a predetermined timing. The reference numerals 110a, 110b, 110c, and 110d denote beacon frames corresponding to reference frames. The reference numerals 111a, 111b, and 111c denote data frames transmitted from the administration terminal 1a, the communication terminals 2a and 2b, respectively. The reference numerals 122a, 122b, and 122c denote ACK frames transmitted from the administration terminal 1a, the communication terminals 2a and 2b, respectively. The reference numeral 113a denotes a reference frequency duration, and the reference numeral 114a denotes a non-reference frequency duration.

In FIG. 8, the beacon frames 110a, 110b, 110c, and 110d are transmitted from the administration terminal 1a through the channel CH1 within a beacon frame interval 112, and the communication terminals 2a and 2b receive these beacon frames through the channel CH1. In this case, it is assumed that the beacon frame interval 112 is set to 20 ms, and the voice data are sampled with an interval of 20 ms. Therefore, one data frame 111a is provided for transmission from the administration terminal 1a to each of the communication terminals 2a and 2b, and one data frame 111b and 111c is provided for transmission from each of the communication terminals 2a and 2b, respectively, to the administration terminal 1a within the beacon frame interval 112. In this embodiment, the number of the non-reference frequencies is set to 1, the channel CH11 is set to the non-reference frequency, a time period elapsed from the beacon frame for changing to the non-reference frequency is set to 10 ms, and the non-reference frequency duration is set to 10 ms. In other words, the reference frequency duration 113a and the non-reference frequency duration 114a are similarly set to 10 mm. In addition, it is assumed that the communication terminal 2a suffers from interference in the channel CH1 along both directions between the administration terminal 1a and the communication terminal 2a, the data frames 111a and 111b should be transmitted through the channel CH11 therebetween, the communication terminal 2b does not suffer from interference in any of the channels CH1 and CH 11 along both directions between the administration terminal 1a and the communication terminal 2b, and the data frames 111a and 111c can be transmitted through any of the channels CH1 and CH11 therebetween.

Hereinafter, the timing chart of FIG. 8 will be described in detail. The main controller 51a of the administration terminal 1a transmits the beacon frame 110a to the transmitter 90 after setting the channel CH1 in the frequency switching unit 59a1. Since the beacon frame 110a is a broadcast frame, which does not have a retrial, the beacon frame 110a is transmitted with a transmission rate of 1 Mbps in order to allow each communication terminal to safely receive it, so that it can be received even by the communication terminal 2a suffering from the interference from the administration terminal 1b. Frames other than the beacon frame are transmitted with a transmission rate of 11 Mbps, which is higher than 1 Mbps.

Then, since voice data to the communication terminal 2b that can be transmitted through the channel CH1 is arrived in the administration terminal 1a, the main controller 51a transmits the arrived data frame 111a to the transmitter 90 without waiting for switching into any transmittable channel. The receiver 100 of the communication terminal 2b receives the data frame 111a, and passes it to the main controller 31a via a wireless MAC 31c. In this case, the wireless MAC 31c transmits an ACK frame for notifying the administration terminal 1a of a fact that the data frame 111a is received. Subsequently, the main controller 31a of the communication terminal 2b transmits the data frame 111c to the transmitter 90 because the voice data can be prepared. Then, the wireless MAC 31c receives the ACK frame 122a transmitted from the administration terminal 1a via the receiver 100 to perceive that the administration terminal 1a has normally received the data frame 111c, and the data frame 111c is not re-transmitted. Similarly, the MAC 59a of the administration terminal 1a receives the ACK frame 122c transmitted from the communication terminal 2b via the receiver 80 to perceive that the communication terminal 1c has normally received the data frame 111a, and the data frame 111a is not re-transmitted. Subsequently, the receiver 80 of the administration terminal 1a receives the data frame 111c from the communication terminal 2b, and the MAC 59a transmits an ACK frame 122a for notifying the communication terminal 2b of a fact, that the data frame 11a has been received, to the transmitter 70. This procedure is a sequence for delivering the voice data in both directions.

Then, when a time period of 10 ms is elapsed from the beacon frame for switching into the non-reference frequency, the main controller 51a of the administration terminal 1a issues an instruction for switching into the channel CH11 to the frequency switching unit 59a1, and the frequency switching unit 59a1 is switched into the channel 11. Similarly, each main controller 31a of the communication terminals 2a and 2b issues an instruction for switching into the channel CH11 to each frequency switching unit 31c1, and each frequency switching unit 31c1 is switched into the channel 11.

Subsequently, the voice data destined for the communication terminal 2a that can be communicated only through a non-reference frequency channel CH11 is received, and the voice data destined for the administration terminal 1a is prepared. Therefore, as described above, a bidirectional delivering sequence of the voice data is performed for the voice data in both directions between the administration terminal 1a and the communication terminal 2a without waiting for frequency switching.

Then, when a time period of 10 ms corresponding to the non-reference frequency duration is elapsed, the main controller 51a of the administration terminal 1a issues an instruction for switching into the channel CH1 to the frequency switching unit 59a1, and the frequency switching unit 59a1 is switched into the channel CH1. Similarly, each main controller 31a of the communication terminals 2a and 2b issues an instruction for switching into the channel CH1 to each frequency switching unit 31c1, each frequency switching unit 31c is switched into the channel CH1, and the beacon frame 110b is transmitted/received. For sequences that follow after that within the beacon frame interval, the aforementioned operations are similarly repeated.

Needless to say, although the present embodiment has been described for a case that two communication terminals are provided in order to particularly describe operations of the communication terminals 2a and 2b, the number of the communication terminals may be any number. Although the number of the non-reference frequencies switched within the beacon frame interval is one, and the number of the switching operations is also one in this embodiment, any number of switching operations may be performed to a plurality of non-reference frequencies during that time if the switching into the reference frequency is completed until the beacon frame is transmitted/received. Also, for the communication terminal 2b, although the description has been made for a case that the frequency switching is performed within the beacon frame interval, the frequency may be not switched within the beacon frame interval when another terminal having the same frequency as the switched non-reference frequency exits near the communication terminal 2b, the communication terminal 2b exists within an area where the RF waves of another terminal can be reached, and a new kind of interference is generated even if the frequency is switched. Although the description has been made to a case that the communication terminal 2a is interfered with another administration terminal which uses the same frequency, this embodiment may be similarly applied to a case that the administration terminal 1a or the communication terminal 2b is interfered, and a case that the interference source is another electronic device which uses the same frequency.

According to the present embodiment, a communication system includes an administration terminal and a plurality of communication terminals, and the communication terminals are administrated by the administration terminal. Between the administration terminal and the communication terminals, while the reference frequency for transmitting/receiving the beacon frame is not changed, the switching into the non-reference frequency different from the reference frequency is performed at least one time within the beacon frame interval at the same timing, and frames are transmitted/received using at least one frequency including this reference frequency and at least one non-reference frequency, so that the frames can be transmitted/received even in the non-reference frequency to avoid the interfering reference frequency. As a result, it is advantageous that the frames can be safely transmitted/received between the administration terminal and the communication terminal.

Although the description has been made in the present embodiment to a case that the reference frame is a beacon frame, there is a delivery traffic indication message (DTIN) functioning as a basis of a plurality of beacon frames (please, refer to ANSI/IEEE Std. 802.11,1999), and that may be used as the reference frame.

### Embodiment 2

The second embodiment of the present invention will be described with reference to FIGS. 6, 7, 9, 11, 12, 13, 14 and 16. Similarly to the first embodiment, the second embodiment uses the configurations shown in FIGS. 1 to 5.

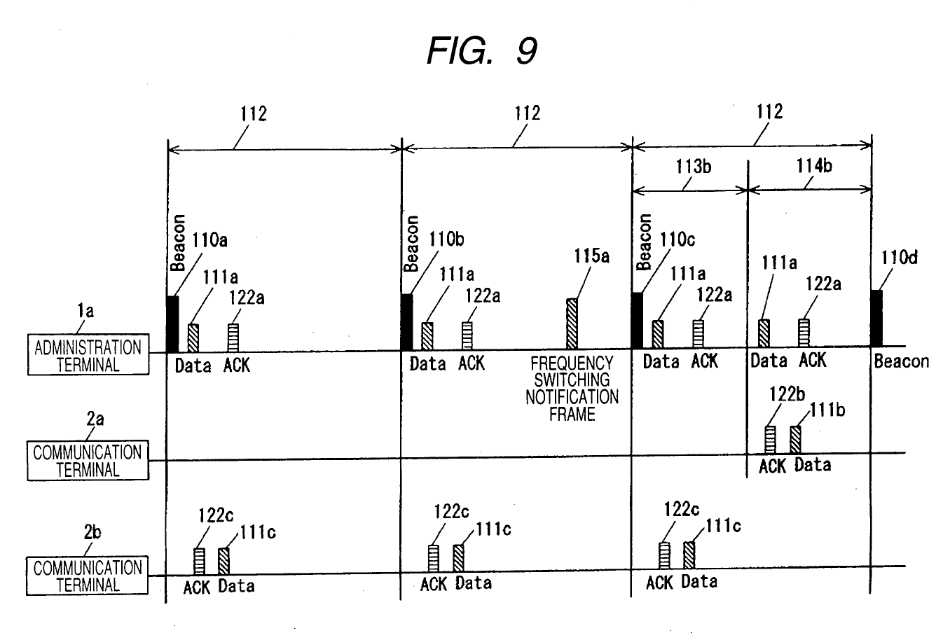

FIG. 9 is a timing chart of a communication system at a predetermined timing according to the second embodiment. Like reference numerals denote like elements throughout the first and second embodiments.

In the second embodiment, the administration terminal 1a notifies the communication terminals 2a and 2b of the information required in frequency switching using a beacon frame and a frequency switching notification frame defined in this embodiment that uses an Action frame defined in IEEE 802.11. Firstly, these two frames will be described.

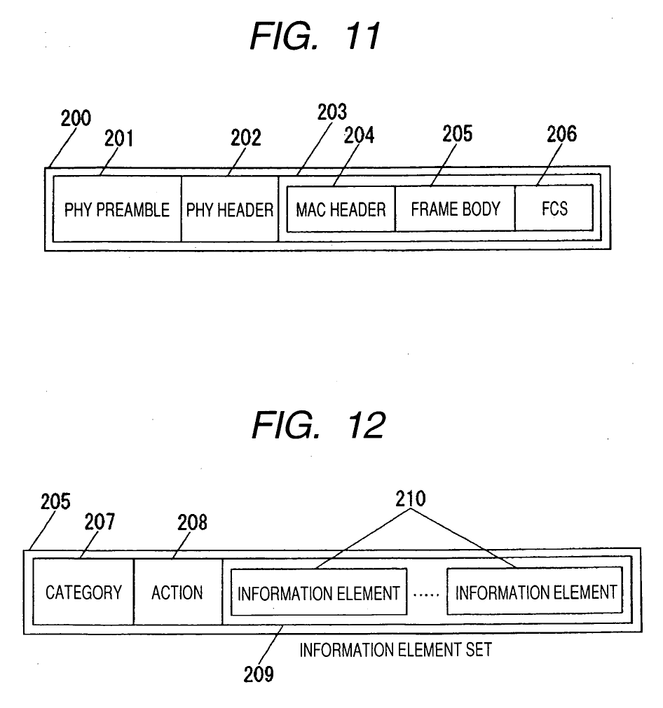

FIG. 11 is a constructional diagram illustrating a physical layer frame in a standard IEEE 802.11. The reference numeral 200 denotes an IEEE 802.11 physical layer frame transmitted into the air. The reference numeral 201 denotes a physical layer (PHY) preamble added to the physical layer to obtain synchronization. The reference numeral 202 denotes a PHY header added to the physical layer. The PHY header 202 may indicate a data rate or a data link layer frame length. The reference numeral 203 denotes a data link layer frame of IEEE 802.11. The reference numeral 204 denotes a media access control (MAC) header, and the MAC header 204 represents what kind of frame is, whether the power save mode is operated, a destination address, a transmitting source address, or the like. The reference numeral 205 denotes a frame body. Various data are stored in the frame body 205 based on the details of the MAC header 204. The reference numeral 206 denotes a female check sequence (FCS), and represents a 32 bit cyclic redundancy check (CRC) code calculated from the MAC header 204 and the frame body 205 in order to identify reliability of the details of the MAC header 204 and the frame body 205.

FIG. 12 is a constructional view illustrating details of a frame body of an Action frame. The “Category” 207 is one byte information for identifying what category a frame corresponds to. The “Action” 208 is one byte information for identifying what kind of operation in the category 207 a frame performs. The “Information Element Set” 209 is a set of information elements 210, required to perform the operation of the Action 208. The information element set 209 has at least one information element 210, and the number of bytes in the information elements 210 is variable.

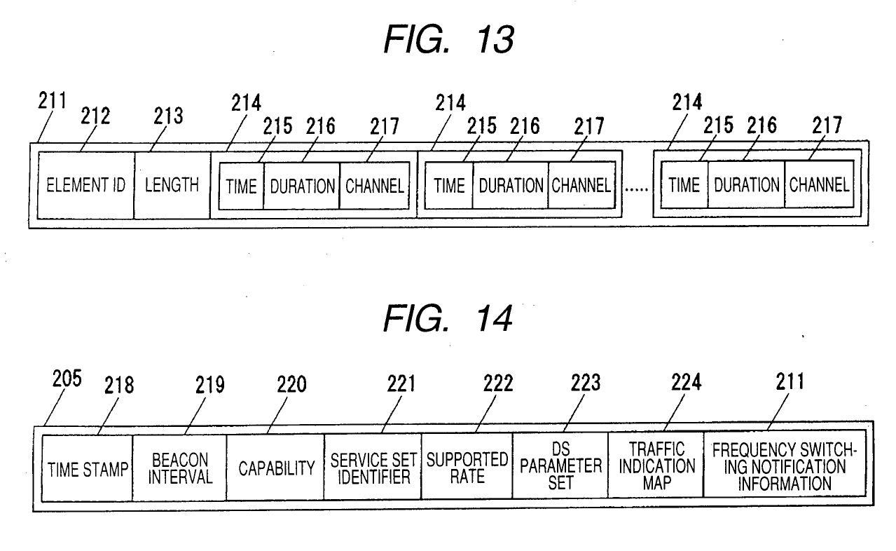

FIG. 13 is a diagram illustrating details of a piece of personal frequency switching notification information 211 of the information element 210. The “Element ID” 212 is one byte information for identifying which one of a plurality of information elements 210 is selected. In the frequency switching notification information 211, a number “254” is allocated according to a standard IEEE 802.11. The “Length” 213 indicates the length of the frequency switching notification information. The “Time” 215 indicates a time period required to switch into the non-reference frequency within a beacon frame interval and elapsed from the beacon frame. The “Duration” 216 indicates a time period for maintaining the non-reference frequency. The “Channel” 217 indicates the non-reference frequency to be switched. Unit of the Time 215 and the Duration 216 is “ms”. The frequency switching information set 214 includes three values including the Time 215, Duration 216, and Channel 217. The frequency switching information set 214 is required as much as the number of frequency switching operations within a beacon frame interval. Each of the three values included in the frequency switching information set 214 has a length of one byte. The Length 213 has a length of (3×the number of the frequency switching information sets 214) bytes.

Since the frequency switching notification frame uses a format of the Action frame, a number “255”, which represents a frequency switching operation, is stored in the Category 207 as reserved in IEEE 802.11, and a number “0”, which indicates a frequency switch notification, is stored in the Action 208.

FIG. 14 is a diagram illustrating details of a frame body 205 in the beacon frames 110a, 110b, 110c, and 110d. The “Time Stamp” 218 stores temporal information functioning as a basis for obtaining synchronization between the administration terminal 1a and the communication terminals 2a and 2b administrated by the administration terminal 1a. The “Beacon Interval” 219 stores a time period of the beacon frame interval 112. The “Capability” 220 stores whether or not capabilities such as a physical communication method of the administration terminal 1a can be provided. The “Service Set Identifier” 221 stores information for identifying a wireless network administrated by the administration terminal 1a. The “Supported Rate” 222 stores a data rate that can be supported by the administration terminal 1a. The “DS Parameter Set” 223 stores a frequency that is being currently used by the administration terminal 1a. Among the beacon frames 110a, one per several beacon frames is selected as a main beacon frame. The “Traffic Indication Map” 224 stores information on how many beacon frames are provided between each main beacon frame or the number of the beacon frames required to reach the next main beacon frame. The items from the Timestamp 218 to the Traffic Indication Map 224 have been conventionally used, and frequency switching notification information 211 is newly added to the end of them in the present embodiment. According to the conventional art, the items from the Timestamp 218 to the Traffic Indication Map 224 are not necessarily provided, and other information may be provided. Similarly, the present embodiment is not limited to the above items.

Hereinafter, operations of a communication system according to the present embodiment will be described.

FIG. 9 is a timing chart of a communication system at any timing according to the second embodiment. The reference numeral 113b denotes a reference frequency duration, and the reference numeral 114b denotes a non-reference frequency duration. In FIG. 9, beacon frames 110a, 110b, 110c, and 110d are transmitted from the administration terminal 1a through the channel CH1 with a beacon frame interval 112, and the communication terminals 2a and 2b receive these beacon frames through the channel CH1. In this case, it is assumed that the beacon frame interval 112 is set to 20 ms, and the voice data are sampled with an interval of 20 ms. Therefore, one data frame 111a is provided for transmission from the administration terminal 1a to each of the communication terminals 2a and 2b, and one data frame 111b and 111c is provided for transmission from each of the communication terminals 2a and 2b, respectively, to the administration terminal 1a within the beacon frame interval 112. Although it is illustrated in FIG. 9 that a calling between the administration terminal 1a and the communication terminal 2a is initiated by transmitting the data frame 111a, in fact, frames are transmitted/received using a call initiation protocol such as SIP before a calling is initiated. However, in this embodiment, these are omitted in their relating drawings and descriptions for convenient descriptions.

Hereinafter, the timing chart of FIG. 9 will be described in detail. The main controller 51a of the administration terminal 1a transmits the beacon frame 110a from the transmitter 90 after the channel CH1 is set in the frequency switching unit 59al. Since the beacon frame 110a is a broadcast frame, which does not have a retrial, the beacon frame 110a is transmitted with a transmission rate of 1 Mbps in order to allow each communication terminal to safely receive it, so that it can be received even by the communication terminal 2a suffering from the interference from the administration terminal 1b. The frequency switch notification frame is transmitted with a transmission rate of 1 Mbps, and frames other than the beacon frame and the notification frame are transmitted with a transmission rate of 11 Mbps, which is higher than 1 Mbps.

At the initial time point of FIG. 9, the administration terminal 1a and the communication terminals 2a and 2b do not perform the frequency switching operation within the beacon frame interval. However, only the administration terminal 1a and the communication terminal 2b are in a calling state, and the data frames are transmitted/received through the channel 11. At the initial time point, although the administration terminal 1a perceives that the communication terminal 1a suffers from interference through the channel CH1 based on frame error frequency until now, the frequency switching is not performed within the beacon frame interval because a calling is not made currently and the data frame frequency is low between the administration terminal 1a and the communication terminal 2a. In this situation, when the voice data destined for the communication terminal 2a is arrived in the administration terminal 1a, the data frame frequency between the administration terminal 1a and the communication terminal 2a is increased, and thus, the interference of the communication terminal 2a in the channel CH1 cannot be neglected. Therefore, the frequency switching is dynamically performed within the beacon frame interval 112 on the basis of determination of the administration terminal 1a.

The interference detector 59a2 of the administration terminal 1a identifies whether or not the interference is periodically generated, and detects the interference for the communication terminal 2a, even after the beacon frame 110b is transmitted, to notify it to the main controller 51a. The main controller 51a generates the frequency switching notification information 211 based on the notified information. A number “11” is set to the Channel 217. Since the number of the communication terminals that are calling with the administration terminal 1a and periodically transmit/receive data with the administration terminal 1a is two, and the number of the communication terminals suffering from interference among of them is one, the number of the non-reference frequencies is one, the beacon frame interval 20 ms is equally divided to two, and a number 10 is set to the Time 215 and the Duration 216. Since the number of the non-reference frequencies is one, the number of the frequency switching information sets 214 is also set to one, and the length 213 is set to three. The main controller 51a generates the frequency switching notification frame 115a including this frequency switching notification information 211 to transmit it from the transmitter 70 to the communication terminals 2a and 2b.

Then, when the time for transmitting the beacon frame is reached, the administration terminal 1a adds the generated frequency switching notification information 211 to the frame body of the beacon frame 110c as shown in FIG. 14, and transmits the beacon frame 110c to the transmitter 90. Accordingly, the voice data that can be transmitted to the communication terminal 2b through the channel 1 is arrived, and the voice data destined for the administration terminal 1a is prepared. Therefore, a voice data delivering sequence is performed between the administration terminal 1a and the communication terminal 2b as described in association with the first embodiment without waiting for switching into the transmittable channel.

Subsequently, the value of the Time 215 for the frequency switching notification information 211 corresponding to the time elapsed from the beacon frame for switching into the non-reference frequency reaches 10 ms, the main controller 51a of the administration terminal 1a issues to the frequency switching unit 59a1 an instruction for switching the channel into the value “11” designated in the Channel 217 of the frequency switching notification information 211, and the frequency switching unit 59a1 switches the frequency into the channel CH11. Similarly, each main controller 31a of the communication terminals 2a and 2b issues to the respective frequency switching unit 31c1 an instruction of switching the channel into CH11, and the respective frequency switching unit 31c1 switches the frequency into CH11.

In addition, the voice data destined for the communication terminal 2a of which the communication can be made only in the non-reference frequency CH11 is arrived, and the voice data destined for the administrative terminal 1a is prepared. Accordingly, a voice data delivering sequence is performed between the administration terminal 1a and the communication terminal 2a without waiting for the frequency switching for all of the voice data in both directions as described above in the first embodiment.

Then, when the value of the Duration 216 of the frequency switching notification information 211, corresponding to the non-reference frequency duration, reaches 10 ms, the main controller 51a of the administration terminal 1a issues to the frequency switching unit 59a1 an instruction for switching into CH1, and the frequency switching unit 59a1 switches the frequency into CH1. Similarly, each main controller 31a of the communication terminals 2a and 2b issues to each frequency switching unit 31c1 an instruction for switching into CH1, and each frequency switching unit 31c1 switches the frequency into CH1, so that the beacon frame 110d is transmitted/received. In sequences that follow after that within the beacon frame interval, the aforementioned operations are similarly repeated.

Although the descriptions have been made in the present embodiment to a case that a state that the frequency switching is not performed within the beacon frame interval is processed to a state that the frames are transmitted/received by determining the non-reference frequency and the durations for the reference frequency and the non-reference frequency based on determination of the administration terminal, notifying them to the communication terminal, and switching the frequency within the beacon frame interval, the method of the present embodiment, in which the administration terminal dynamically generates the frequency switching notification information and transmits it to the communication terminal to switch the frequency within the beacon frame interval and transmit/receive frames, may be effective to a case that the administration terminal dynamically generates the frequency switching notification information obtained by changing the non-reference frequency or the frequency duration and notifies it to the communication terminal to transmit/receive frames in the state that the frequency is being switched at a predetermined timing within the beacon frame interval to transmit/receive frames. The frequency switching notification information may be not limited to a format of the frequency switching information set 214. Unit of the Time 215 or Duration 216 is not limited to ms, and may be As. In addition, although the descriptions have been made to a case that the communication terminal 2b also performs the frequency switching within the beacon frame interval, the frequency may be not switched within the beacon frame interval when another terminal having the same frequency as the switched non-reference frequency exists in the vicinity of a certain terminal, and the certain terminal exists within the range where the RF waves from another terminal can be reached, so that additional interference is generated even when the frequency is switched. In addition, although the descriptions have been made to a case that the communication terminal 2a is interfered from another administration terminal that uses the same frequency, the present invention may be similarly applied to a case that the interference is generated in the administration terminal 1a or the communication terminal 2b or a case that the interference is generated in other electric devices of which the interference sources use the same frequency.

As described above, according to the present embodiment, a communication system includes an administration terminal and communication terminals, and the communication terminal is administrated by the administration terminal. The administration terminal dynamically generates frequency switching notification information including at least one of a frequency, timing, and duration of a non-reference frequency, and transmits the frequency switching notification information by either adding it to a reference frame or generating a frequency switching notification frame including the frequency switching notification information. The reference frequency for transmitting/receiving beacon frames between the administration terminal and the communication terminal is fixed, one or more switching operations into the non-reference frequency are performed at the same timing within the beacon frame interval based on the frequency switching notification information, and one or more frequencies including the reference frequency and one or more non-reference frequencies are used to transmit/receive frames. As a result, the non-reference frequency or the frequency duration can be optimally determined as occasion occurs depending on interference conditions. Therefore, it is possible to transmit/receive frames in more improved communication conditions.

### Embodiment 3

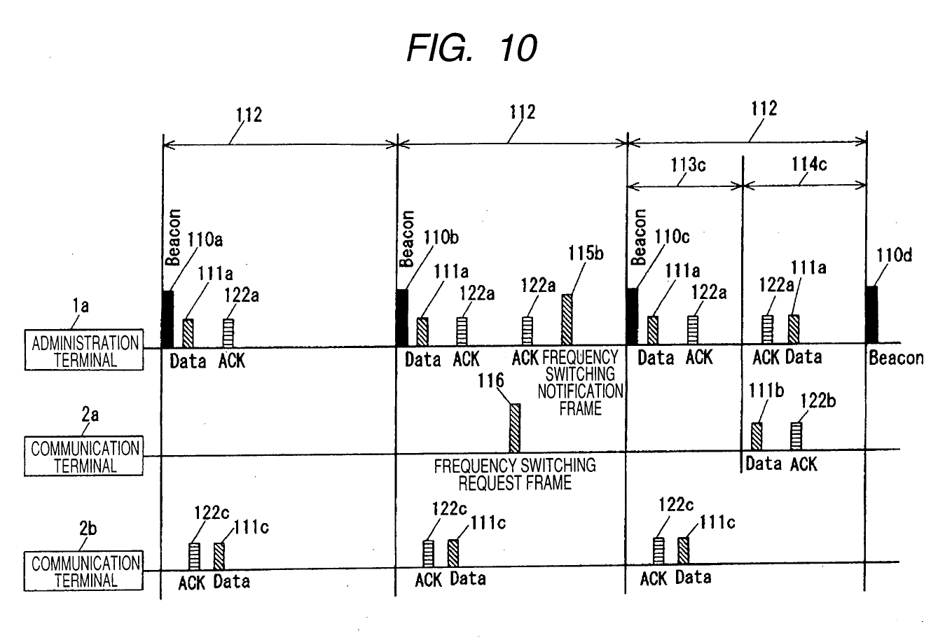

The third embodiment of the present invention will be described with reference to FIGS. 6, 7, 10, 11, 12, 15, and 16. Similarly to the first embodiment, the third embodiment uses the constructions shown in FIGS. 1 to 5. FIG. 10 is a timing chart of a communication system operated at any timing according to the third embodiment, wherein like elements denote like elements throughout the first to third embodiments.

In the present embodiment, the information required by the communication terminal 2a to request frequency switching is notified to the administration terminal 1a using a frequency switching request frame defined in the present embodiment by a format of an Action frame defined in a standard IEEE 802.11. Firstly, a frequency switching request frame will be described.

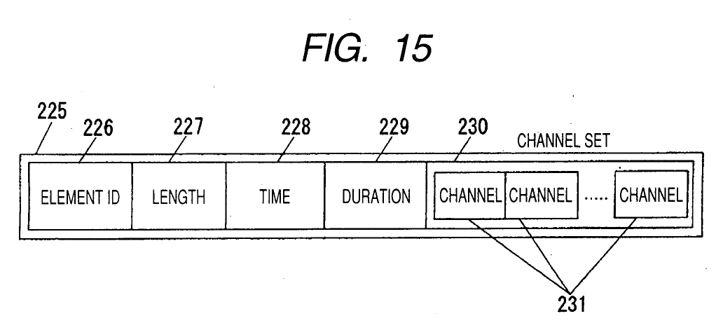

FIG. 15 is a diagram illustrating items of personal frequency switching request information 225 of an information element 210. The “Element ID” 226 is one-byte information for identifying which one of a plurality of information elements 210 is selected, and a number “255” is allocated to the Element ID 226 of the frequency switching request information 225 as reserved in a standard IEEE 802.11. The “Length” 227 denotes the length of the frequency switching request information. The “Time” 228 denotes the time required to switch into the non-reference frequency within the necessary beacon frame interval and elapsed from the beacon frame. The “Duration” 229 denotes the required non-reference frequency duration. Unit of the time 228 and Duration 229 is “ms”. The “Channel Set” 230 may include one or more channels, and the Channel 231 denotes a deniable frequency value. The Channel Set 230 contains channels 231 corresponding to the number of the deniable frequencies. Each of the Time 228, Duration 229, and Channel 231 has a length of one byte, and the Length 227 has a length of (2+the number of the Channel 231) bytes.

The frequency switching request frame is a format of an Action frame. The Category 207 stores a value “255” (which indicates frequency switching) reserved in a standard IEEE 802.11. The Action 208 stores a value “1” which indicates a frequency switching request.

Hereinafter, operations of the communication system according to the present embodiment will be described.

FIG. 10 is a timing chart of a communication system at any timing according to the third embodiment, wherein the reference numeral 113c denotes a reference frequency duration, and the reference number 114c denotes a non-reference frequency duration. In FIG. 10, beacon frames 110a, 110b, 110c, and 110d are transmitted from the administration terminal 1a within a beacon frame interval 112 through a channel CH1, and the communication terminals 2a and 2b receive these beacon frames. In this case, it is assumed that the beacon frame interval 112 is set to 20 ms, and the voice data are sampled with an interval of 20 ms. Therefore, one data frame 11a is provided for transmission from the administration terminal 1a to each of the communication terminals 2a and 2b, and one data frame 111b and 111c is provided for transmission from each of the communication terminals 2a and 2b to the administration terminal 1a within the beacon frame interval 112. Although it is illustrated in FIG. 10 that a calling between the administration terminal 1a and the communication terminal 2a is initiated by transmitting the data frame 111b, in fact, frames are transmitted/received using a call initiation protocol such as SIP before a calling is initiated. However, in this embodiment, these are omitted in the relating drawings and their descriptions for convenient descriptions.

Hereinafter, the timing chart of FIG. 10 will be described in detail. The main controller 51a of the administration terminal 1a transmits the beacon frame 110a from the transmitter 90 after the channel CH1 is set in the frequency switching unit 59a1. Since the beacon frame 110a is a broadcast frame, which does not have a retrial, the beacon frame 110a is transmitted with a transmission rate of 1 Mbps in order to allow each communication terminal to safely receive it, so that it can be received by even the communication terminal 2a suffering from the interference from the administration terminal 1b. The frequency switching frame is transmitted with a transmission rate of 1 Mbps, and the beacon frames and frames other than the notification frame are transmitted with a transmission rate of 11 Mbps, which is higher than 1 Mbps.

At the initial time point of FIG. 10, the administration terminal 1a and the communication terminals 2a and 2b do not perform the frequency switching operation within the beacon frame interval. However, only the administration terminal 1a and the communication terminal 2b are in a calling state, and the data frames are transmitted/received through the channel CH1. At the initial time point, although the administration terminal 1a perceives that the communication terminal 1a suffers from interference through the channel CH1 based on frame error frequency until now, the frequency switching is not performed within the beacon frame interval because a calling is not made currently and the data frame frequency is low between the administration terminal 1a and the communication terminal 2a. In this situation, when the voice data destined for the administration terminal 1 a is prepared in the communication terminal 2a, the data frame frequency between the administration terminal 1a and the communication terminal 2a is increased. As a result, the interference on the communication terminal 2a through the channel CH1 cannot be neglected. Accordingly, the communication terminal 2a transmits to the administration terminal 1a a frequency switching request within a beacon frame interval 112 to perform frequency switching within a beacon frame interval 112.

The interference detector 31c2 of the communication terminal 2a identifies whether or not the interference is periodically generated, and detects the interference on the communication terminal 2a, even after the beacon frame 110b is transmitted, to notify it to the main controller 31a. The main controller 31a generates the frequency switching request information 225 based on the notified information on the interference. Since the communication terminal 2a perceives that the communication terminal 2a exists within the range of the administration terminal 1b which uses the channel CH1, a number “1” is set in the “Channel” 231 as a deniable frequency. Since it is perceived that the data frame 111b is transmitted from the communication terminal 2a, for example, within 11 ms after the administration terminal 1a transmits the beacon frame 1110c, “10” is set in the “Time” 228 before 1 ms. Therefore, it is perceived that 14 ms is required after the communication terminal 2a transmits the data frame 111b before the administration terminal 1a transmits the data frame 111a. Accordingly, “3” is set in the Duration 229 in order to request 3 ms as a non-reference frequency duration in consideration with the retrial time. Since one channel 231 is provided, the Channel Set 230 is designated as one byte, and “3” representing 3 bytes is set in the “Length” 227. The frequency switching request frame 116 including this frequency switching request information 225 is generated and transmitted to the administration terminal 1a.

In the administration terminal 1a, the frequency switching request detector 59a3 detects a frame including the frequency switching request information 225 of FIG. 15 among the frames received by the receiver 80 of FIG. 6, and notifies the frequency switching request information 225 to the main controller 51a. In addition, the interference detector 59a2 detects interference on the communication terminals 2a and 2b or the administration terminal 1a, and the main controller 51a generates frequency switching notification information 211 based on the information detected by the interference detector 59a2 or the notified frequency switching request information 225. “11” is set in the Channel 217, and two communication terminals have a call with the administration terminal 1a and periodically transmits/receives data with it. Among them, one communication terminal suffers from interference. Therefore, the number of the non-reference frequency is set to “1”, the beacon frame interval 20 ms is equally divided into two, and “10” is set in the Time 215 and the Duration 216. The main controller generates the frequency switching notification frame 115a including this frequency switching notification information 211, and transmits it from the transmitter 70 to the communication terminals 2a and 2b.

Then, when the time for transmitting the beacon frame is reached, the administration terminal 1a adds the generated frequency switching notification information 211 to the frame body of the beacon frame 110c as shown in FIG. 14, and transmits the beacon frame 110c to the transmitter 90, so that the voice data destined for the communication terminal 2b that can be transmitted through the channel CH1 is arrived, and the voice data destined for the administration terminal 1a is prepared. Accordingly, as already described above in the first embodiment, a voice data delivering sequence can be performed between the administration terminal 1a and the communication terminal 2b without waiting for switching into the transmittable channel.

Subsequently, the value of the Time 215 for the frequency switching notification information 211 corresponding to the time elapsed from the beacon frame for switching into the non-reference frequency reaches 10 ms, the main controller 51a of the administration terminal 1a issues to the frequency switching unit 59a1 an instruction for switching the channel into the value 11 designated in the Channel 217 of the frequency switching notification information 211, and the frequency switching unit 59a1 switches the frequency into the channel CH11. Similarly, each main controller 31a of the communication terminals 2a and 2b issues to the respective frequency switching unit 31c1 an instruction of switching the channel into CH11, and the respective frequency switching unit 31c1 switches the frequency into CH11.

In addition, the voice data destined for the communication terminal 1a of which the communication can be made only in the non-reference frequency CH11 is prepared in the communication terminal 2a, and the voice data destined for the communication terminal 2a is arrived in the administrative terminal 1a. Accordingly, a voice data delivering sequence is performed between the administration terminal 1a and the communication terminal 2a without waiting for the frequency switching for all of the voice data in both directions as described above.

Then, when the value of the Duration 216 of the frequency switching notification information 211, corresponding to the non-reference frequency duration, reaches 10 ms, the main controller 51a of the administration terminal 1a issues to the frequency switching unit 59a1 an instruction for switching into CH1, and the frequency switching unit 59a1 switches the frequency into CH1. Similarly, each main controller 31a of the communication terminals 2a and 2b issues to each frequency switching unit 31c1 an instruction for switching into CH1, and each frequency switching unit 31c1 switches the frequency into CH1, so that the beacon frame 110d is transmitted/received. In sequences that follow after that within the beacon frame interval, the aforementioned operations are similarly repeated by adding the frequency switching notification information to the frame body 205 of the beacon frame.

In the present embodiment, although the descriptions have been made to a case that a state that the frequency switching is not performed within the beacon frame interval is processed to a state that the frames are transmitted/received such that the communication terminal detects interference and issues a request to the communication terminal, and the administration terminal determines the non-reference frequency and durations of the reference frequency and the non-reference frequency based on the issued request and notifies it to the communication terminal to switch the frequency within a beacon frame interval 112, the method of transmitting/receiving frames, in which the communication terminal detects interference and dynamically issues a request to the administration terminal, and the administration terminal generates the frequency switching notification information and transmits it to the communication terminal to switch the frequency within the beacon frame interval 112, may be effective to a case that the administration terminal dynamically generates the frequency switching notification information obtained by changing the non-reference frequency or the frequency duration based on the request from the communication terminal and notifies it to the communication terminal to switch the frequency within the beacon frame interval 112 in a new non-reference frequency or duration and transmit/receive frames, in the state that the frequency is being switched at a predetermined timing within the beacon frame interval to transmit/receive frames. In addition, although the descriptions have been made to a case that the communication terminal 2b also performs the frequency switching within the beacon frame interval 112, the frequency may be not switched within the beacon frame interval 112 when another terminal having the same frequency as the switched non-reference frequency exists in the vicinity of a certain terminal, and the certain terminal exists within the range where the RF waves from another terminal can be reached, so that additional interference is generated even when the frequency is switched. In addition, although the descriptions have been made to a case that the communication terminal generates the frequency switching request information and transmits the frequency switching request frame to the administrations terminal, the frequency switching request information may be added to frames of another purpose, such as a data frame, and then be transmitted. In addition, although the descriptions have been made to a case that the communication terminal 2a suffers from interference from another administration terminal that uses the same frequency, the present invention may be similarly applied to a case that the interference is generated in the administration terminal 1a or the communication terminal 2b or a case that the interference is generated in other electric devices of which the interference sources use the same frequency.

As described above, according to the present embodiment, the communication system includes an administration terminal and communication terminals, and the communication terminals are administrated by the administration terminal. The communication terminal detects one or both of interference on the administration terminal and interference on the communication terminal that is administrated by the administration terminal, adds the frequency switching request information for requesting the frequency switching to a frame having another purpose, and transmits it to the administration terminal, or/and generates the frequency switching request notification frame including the frequency switching request information and transmits it in one or both directions. The administration terminal generates the frequency switching notification information based on the frequency switching request information included in the received frame and the interference information detected by itself, transmits the frame including the frequency switching notification information to the communication terminal. Between the administration terminal and the communication terminals, while the reference frequency for transmitting/receiving the beacon frames is not changed, the switching is performed into a non-reference frequency different from the reference frequency at least one time within the beacon frame interval at the same timing, and frames are transmitted/received using at least one frequency including this reference frequency and at least one non-reference frequency. As a result, the non-reference frequency or the frequency duration can be optimally determined as occasion occurs depending on interference conditions. Therefore, it is possible to transmit/receive frames in more improved communication conditions.

This application is based upon and claims the benefit of priority of Japanese Patent Application No. 2005-219980 filed on Jul. 29, 2005, the contents of which are incorporated herein by reference in its entirety.

The communication system according to the present invention is advantageous in that it can be portably used together with wireless LAN electronic devices that are susceptible to interference between devices observing the same standard because the number of channels that can be simultaneously used is small, and also susceptible to interference with other electronic devices that does not observe the same standard but uses the same frequency. In addition, the present invention can be applied to the communication system in which a wireless phone terminal of which the interference condition can be dynamically changed is used as a communication terminal.

1. An administration terminal for administrating a communication terminal via a wireless medium, the administration terminal comprising:
a transmitter for transmitting data to the communication terminal;
a receiver for receiving data from the communication terminal;
a frequency switching unit for switching a frequency used in a wireless communication with the communication terminal; and
a main controller for controlling transmission/receipt of the data and frequency switching,
wherein the main controller controls the frequency switching unit to operate in a first frequency, when a reference frame is transmitted, and to operate in a second frequency, that is different from a reference frequency, at an arbitrary time period other than when the reference frame is transmitted.

2. The administration terminal according to claim 1, wherein a plurality of non-reference frequencies different from the reference frequency are used as the second frequency that is used during an arbitrary time period other than when the reference data is transmitted.

3. The administration terminal according to claim 1, wherein the main controller can change the number of the non-reference frequencies that are switched, a frequency of the non-reference frequency, a frequency switching timing, and a duration after the frequency is switched.

4. The administration terminal according to claim 1, wherein the main controller generates frequency switching notification information including at least one of a frequency of the non-reference frequency, a frequency switching timing, and a duration after the frequency is switched and notifies it to the communication terminal.

5. The administration terminal according to claim 4, further comprising a frequency switching request detector for detecting a frequency switching request from the communication terminal,
wherein the main controller generates the frequency switching notification information based on information of the frequency switching request detector.

6. The administration terminal according to claim 4, further comprising an interference detector for detecting one or both of interference on the administration terminal and interference on the communication terminal administrated by the administration terminal,
wherein the main controller generates the frequency switching notification information based on information of the interference detector.

7. The administration terminal according to claim 4, further comprising:
a frequency switching request detector for detecting a frequency switching request from the communication terminal; and
an interference detector for detecting one or both of interference on the administration terminal and interference on the communication terminal administrated by the administration terminal,
wherein the main controller generates the frequency switching notification information based on information detected in the interference detector and the frequency switching request detector.

8. The administration terminal according to claim 4, wherein the main controller adds the frequency switching notification information to the reference data to transmit it, or/and generates a frequency switching notification data including the frequency switching notification information to transmit it.

9. The administration terminal according to claim 8, further comprising a frequency switching request detector for detecting a frequency switching request from the communication terminal,
wherein the main controller generates the frequency switching notification information based on information of the frequency switching request detector.

10. The administration terminal according to claim 8, further comprising an interference detector for detecting one or both of interference on the administration terminal and interference on the communication terminal administrated by the administration terminal,
wherein the main controller generates the frequency switching notification information based on information of the interference detector.

11. The administration terminal according to claim 8, further comprising:
a frequency switching request detector for detecting a frequency switching request from the communication terminal; and
an interference detector for detecting one or both of interference on the administration terminal and interference on the communication terminal administrated by the administration terminal,
wherein the main controller generates the frequency switching notification information based on information detected from the interference detector and the frequency switching request detector.

12. A communication terminal administrated by an administration terminal via a wireless medium, the communication terminal comprising:
a transmitter for transmitting data to the administration terminal;
a receiver for receiving data from the administration terminal;
a frequency switching unit for switching a frequency used in a wireless communication with the administration terminal; and
a main controller for controlling data transmission/receipt and frequency switching,
wherein the main controller controls the frequency switching unit so as to operate in a non-reference frequency different from a reference frequency during any time period other than when the reference data is received from the administration terminal.

13. The communication terminal according to claim 12, wherein the main controller controls the frequency switching unit so as to switch into the reference frequency at the timing that the administration terminal transmits the reference data.

14. The communication terminal according to claim 12, further comprising a frequency switching notification detector for detecting a frequency switching notification from the administration terminal,
wherein the main controller controls the frequency switching unit according to the frequency switching notification information notified from the administration terminal.

15. The communication terminal according to claim 12, wherein the main controller transmits data using a reference frequency and a non-reference frequency different from the reference frequency.

16. The communication terminal according to claim 12, further comprising an interference detector for detecting one or both of interference on the administration terminal and interference on the communication terminal administrated by the administration terminal,
wherein the main controller adds frequency switching request information for requesting frequency switching to the administration terminal to a data having another purpose on the basis of information of the interference detector to transmit it, or/and generates a frequency switching request data including frequency switching request information to transmit it.

17. A wireless communication system including the administration terminal of claim 1 and [a] communication terminal, the communication terminal being administrated by the administration terminal.

18. A wireless communication method implemented in a wireless communication system including an administration terminal for administrating a communication terminal via a wireless medium and a communication terminal administrated by the administration terminal,
wherein the administration terminal transmits a reference data in a reference frequency, and switches into a non-reference frequency different from the reference frequency during an arbitrary time period other than when the reference data is transmitted, and
wherein the communication terminal switches the frequency according to a frequency switching timing of the administration terminal.

19. The wireless communication method according to claim 18, wherein the administration terminal adds frequency switching notification information, including at least one of a frequency of the non-reference frequency, a frequency switching timing, and a duration after the frequency is switched, to a reference data to transmit it, or/and generates frequency switching notification data including the frequency switching notification information to transmit it, and
wherein the communication terminal switches the frequency according to the frequency switching notification information received from the administration terminal.

20. The wireless communication method according to claim 19,
wherein the communication terminal detects one or both of interference on the communication terminal and interference on the administration terminal that administrates the communication terminal and adds the frequency switching request information for requesting frequency switching to the administration terminal to a data having another purpose to transmit it, or/and generates a frequency switching request data including frequency switching request information to transmit it, and
wherein the administration terminal generates frequency switching notification information based on the frequency switching request information of the data received from the communication terminal.

21. The wireless communication method according to claim 19, wherein the administration terminal generates the frequency switching notification information based on one or both of interference on the administration terminal and interference on the communication terminal administrated by the administration terminal.
